(19) United States
(12) Patent Application Publication
(10) Pub. No.: US 2024/0404431 A1
(43) Pub. Date: Dec. 5, 2024

(54) LIGAMENT JOINT SIMULATOR

(71) Applicants: Université de Strasbourg, STRASBOURG (FR); Hôpitaux Universitaires de Strasbourg (HUS), STRASBOURG (FR); Centre national de la recherche scientifique, Paris (FR)

(72) Inventors: Nabil CHAKFE, HINDISHEIM (FR); Matthieu EHLINGER, DUPPIGHEIM (FR); Henri FAVREAU, STRASBOURG (FR); Wissal LACHEGUR, STRASBOURG (FR); Nicole NEUMANN, ILLKIRCH GRAFFENSTADEN (FR)

(21) Appl. No.: 18/697,994

(22) PCT Filed: Oct. 4, 2022
(86) PCT No.: PCT/EP2022/077514

§ 371 Date: Apr. 2, 2024

(30) Foreign Application Priority Data
Oct. 5, 2021 (EP) 21306389.4

(51) Int. Cl. G09B 23/32

(52) U.S. Cl. CPC G09B 23/32

(57) ABSTRACT

A ligament joint simulator including: at least two artificial bones; for each artificial bone, at least one anchoring point on said artificial bone; at least one artificial ligament connecting two anchoring points of a different artificial bone; and an adjustment means connected to the artificial ligaments. The adjustment means is configured to vary at least one biomechanical characteristic of each artificial ligament between the two associated anchoring points independently of the other artificial ligaments. The adjustment means is configured to receive, for each artificial ligament, an associated control signal and to automatically adjust the length of each artificial ligament in accordance with the associated control signal.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### FIELD

The present invention relates to a ligament joint simulator. For example, the simulator is a ligament knee simulator.

### BACKGROUND

A simulator is defined as a tool that allows a contactless experience with a real event. A simulator thereby can be used in medical learning, often difficult under real conditions, and generates no risk for the patient. Errors made in simulation situations are also an opportunity for correction, which is an integral part of the learning methods e.g. for students in medicine or physiotherapy.

Moreover, simulation is a link between theoretical and practical knowledge that increases the part of assimilated knowledge and optimizes the abstraction and conceptualization processes involved in the implementation of skills relating to generalization and improvisation when confronted with an event.

The first advantage of simulation is thus to generate an experience without any risk for the patient. Simulation serves to model all pathologies of the joint and also to confront students with situations which are rare in real-life and, thereby reduce diagnostic errors and the volume of unnecessary complementary examinations afterwards. Finally, the simulation exercises are an opportunity to evaluate skills, analyze each student's progress and provide feedback on personalized experience.

There is a special need to simulate a ligament knee. Indeed, traumatic ligament lesions of the knee are frequent events but the diagnosis thereof remains difficult, especially in emergency services. For example, the annual occurrence of anterior cruciate ligament lesions is 0.81/1000. Nevertheless, half of ligament ruptures are incorrectly diagnosed as a benign knee sprain. moreover, it is established that two different diagnostic tests are needed for establishing an accurate diagnosis. However, some clinical tests appear difficult to implement and the interpretation thereof is often erroneous, such as the pivot shift test. Other rarer lesions are a real diagnostic challenge such as lesions of the posterolateral corner point the diagnosis of which is ignored in nearly three quarters of cases at the time of the initial examination. Finally, rare traumatic events such as knee dislocation provide severe complications due to a diagnosis often delayed due to the deficiency of the initial clinical examination. Experience shows that a medical student will face on average, only five cases of complex lesions during their internship.

In order to overcome such diagnostic errors, the use of supplementary examinations is a common practice in knee traumatology. Nevertheless, for a trained clinician performing a quality clinical examination, carrying out supplementary examinations such as MRI (magnetic resonance image) brings no diagnostic benefit in simple cases and represents a significant financial cost.

Knee simulators for surgical students are known as described e.g., in documents WO 2012/103871 A1 or U.S. Pat. No. 4,850,877. Such simulators comprise an artificial tibia, an artificial femur, and a plurality of artificial ligaments screwed onto the bones. However, such a simulator provides only a limited simulation tool that cannot finely simulate a pathology affecting the knee.

### SUMMARY

Thereby, the goal of the present invention is to propose a ligament knee simulator for a precise and easy adjustment of the knee simulator in order to simulate different types of partial or complete lesions corresponding to different single- or multi-ligament pathologies.

To this end, the subject matter of the invention is a ligament joint simulator comprising: at least two artificial bones; for each artificial bone, at least one anchoring point on said artificial bone; at least one artificial ligament, the or each artificial ligament connecting two anchoring points of a different artificial bone, and means of adjustment connected to the artificial ligaments, the means of adjustment being configured to vary at least one biomechanical characteristic of each artificial ligament between the two associated anchors independently of the other artificial ligaments, the means of adjustment being configured to receive, for each artificial ligament, an associated control signal; the means of adjustment being configured to automatically adjust the length of each artificial ligament according to the associated control signal.

Thereby, the present invention makes it possible to modulate each artificial ligament of the knee simulator, independently of one another, to simulate different types of partial or complete lesions corresponding to different single- or multi-ligament pathologies, the diagnosis of which is difficult but essential and the teaching of which is difficult because it is rare. The simulator according to the invention thus serves for a quality learning experience of the clinical examination for students, often difficult in real-life conditions, rare in terms of frequency, and without any risk for the patient.

According to other advantageous aspects of the invention, the simulator comprises one or a plurality of the following features, taken individually or according to all technically possible combinations:
the ligament simulator is a ligament knee simulator, at least two artificial bones each selected from the group consisting of: an artificial femur, an artificial tibia, an artificial patella and an artificial fibula;
at least two artificial ligaments have different cross-section surface areas;
each artificial ligament is chosen from the group consisting of: polypropylene; polyamide, in particular nylon; elastomer material; silicone;
each artificial ligament consists of a spring with variable stiffness arranged between the two associated anchoring points;
The means of adjustment comprises at least two actuators, in particular at least two stepper motors, each actuator being connected to a single artificial ligament and being configured to vary the length of said ligament according to the associated control signal;
the means of adjustment further comprises a locking system configured to hold the length of each artificial ligament fixed between the two associated anchoring points;
the locking system comprises a jaw which can be actuated by at least one motorized device, in particular a servomotor, the jaw being suitable for being actuated between an open configuration wherein the artificial ligaments are apt to slide freely in the jaw and a closed configuration wherein the artificial ligaments are held in a fixed position in the jaw;
the simulator further comprises a fixed support, wherein at least one artificial bone is connected to the fixed support by a ball joint;
the simulator further comprises a human-machine interface, a control system and a database, the database including data relating to at least one knee condition, the or each knee condition being characterized by a predefined length for each artificial ligament between the two associated anchoring points; the human-machine interface being configured to acquire an instruction associated with one of the knee conditions from a simulator user; the control system being configured to receive said instruction and to send to the means of adjustment, a control signal for each artificial ligament corresponding to the predefined length associated with said knee condition in the database;
the simulator further comprises at least one accelerometer attached to one of the artificial bones and a memory configured to store the acceleration measurements made by each accelerometer over time;
the simulator further comprises an envelope defining an internal volume wherein the artificial bones are arranged, a foam filling the internal volume.

### BRIEF DESCRIPTION OF THE DRAWINGS

The features and advantages of the invention will appear upon reading the following description, given only as an example, but not limited to, and making reference to the enclosed drawings, wherein:

FIG. 1 is a schematic profile representation of a ligament joint simulator according to the invention;

FIG. 2 is a perspective view of the artificial joints of the simulator shown in FIG. 1;

FIG. 3 is a schematic representation of the means of adjustment of the simulator shown in FIG. 1; and

FIG. 4 is a perspective view of means of adjustment of the simulator shown in FIG. 1.

### DETAILED DESCRIPTION

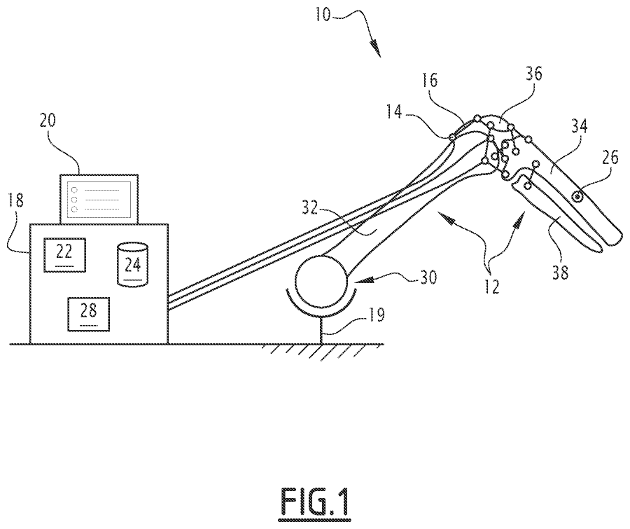

A ligament knee simulator 10 is shown in FIG. 1.

However, a person skilled in the art would understand that the present invention applies in a similar way to any articulation. The simulator is e.g. a shoulder simulator or an ankle simulator.

The simulator 10 comprises at least two artificial bones 12, at least one anchoring point 14 for each artificial bone 12, at least one artificial ligament 16 and a means of adjustment 18.

The simulator 10 also advantageously comprises a fixed support 19, a human-machine interface 20, a control system 22, a database 24 and an accelerometer 26.

The simulator 10 comprises in particular four artificial bones 12, namely an artificial femur 32, an artificial tibia 34, an artificial patella 36 and an artificial fibula 38.

Each artificial bone 12 is e.g. produced by 3D printing.

In order to have the proportions of a human knee, anatomical data of the bone and cartilage structure of a knee are acquired by means of a scanner superimposed on an MRI scan performed on a healthy subject. The data are then processed for the three-dimensional reconstruction of the bony knee and of the cartilaginous articular surface. The 3D reconstruction is used for printing the polymer knee model by means of a 3D printer.

As can be seen in FIG. 1, at least one artificial bone 12 is connected to the fixed support 19 by a ball joint 30. The fixed support 19 is e.g. attached to a table or to a wall. More particularly, the end of the artificial femur 32 is attached to the fixed support 19, the ball joint 30 acting as an artificial hip.

Each anchoring point 14 attached to one of the artificial bones 12 is e.g. a metal loop inserted into the bone 12. In a variant, each anchoring point 14 is glued to the bone 12, screwed into the bone 12 or further printed in 3D with the bone 12. Thereby, the anchoring point 14 forms a link between the bone and the artificial ligament. The anchoring point 14 is either a separate mechanical part or a continuation of the bone 12.

The simulator 10 advantageously comprises at least two artificial ligaments 16, in particular seven artificial ligaments 16.

Each artificial ligament 16 links two anchoring points 14 of a different artificial bone 12.

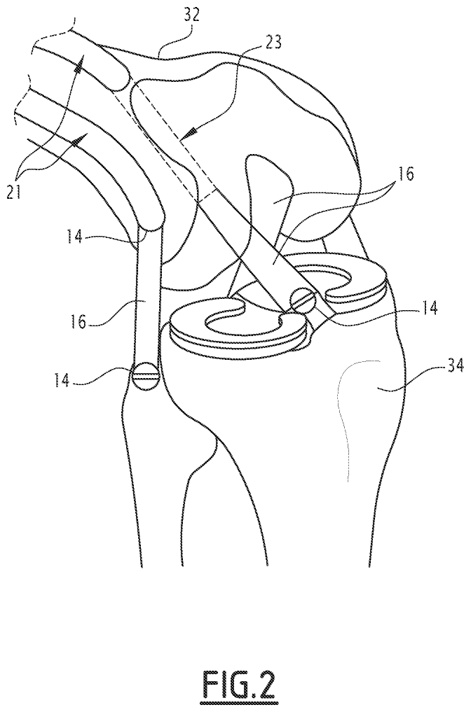

As can be seen in FIG. 2, each artificial ligament 16 is advantageously apt to slide at least partially in a duct 21 and/or a tunnel 23 hollowed out in one of the artificial bones 12.

For example, as shown in FIG. 2, the artificial anterior cruciate ligament is attached between the artificial femur 32 (at the medial side of the lateral condyle, posterior to the lateral intercondylar sulcus) and the artificial tibia 34 (at the anterolateral side of the medial tibial spine). Same is apt to resist the anterior translation of the tibia 34 with respect to the femur 32 (“anterior slide” movement) and the excessive internal rotation of the tibia 34 with respect to the femur 32. The anterolateral ligament is attached between the artificial femur 32 (at the lateral epicondyle) and the artificial tibia 34 (at the lateral and proximal part, posterior to Gerdy's tubercle). Same is suitable for being used for controlling the rotation of the internal tibial and of the pivot shift.

Each artificial ligament 16 is advantageously a cord with a round cross-section. In a variant, each artificial ligament 16 is a strap with a rectangular, oval or oblong cross-section.

Each artificial ligament 16 has a specific transverse dimension (or diameter when the section is round). Thereby, advantageously, at least two artificial ligaments 16 have a different transverse dimension and a different cross-section surface area.

As an example, the anterior cruciate ligament is a cord with a diameter of 4 mm and thus has a cross-section of 12.6 mm². The medial collateral ligament is a cord with a diameter of 2.5 mm and thus has a cross-section of 4.91 mm². The posterolateral corner point is a cord with a diameter of 3 mm and thus has a cross-section of 7.07 mm².

It should be noted that the corner point consisting of a set of ligament structures is modeled herein by a single structure.

Each artificial ligament 26 is composed of a material selected from the group consisting of: polypropylene, an elastomer material such as rubber, silicone, polyamide, in particular nylon.

Such materials make it possible to simulate the artificial ligament 16 by providing a certain extensibility and in particular to reproduce the rupture of the ligament at a given force. The materials are selected, in particular, depending on the elasticity thereof and on the maximum stress before rupture so that same correspond to the real ligaments.

For example, the anterior cruciate ligament is a 4 mm diameter polypropylene rope. The posterior cruciate ligament is a 5 mm diameter polypropylene rope. The medial collateral ligament is a 2.5 mm diameter nylon rope. The lateral collateral ligament is a 1.5 mm diameter nylon rope. The postero-lateral corner point is a 3 mm diameter nylon rope. The postero-medial corner point is a 1.5 mm diameter nylon rope. The anterolateral ligament is a 1 mm diameter nylon rope.

The means of adjustment 18 is linked to the artificial ligaments 16.

More particularly, each artificial ligament 16 is fixedly linked to one of the anchoring points 14 at one end, is apt to slide into the other anchoring point 14 and can advantageously be attached to a dimensionally stable rope 40 at the other end thereof. In a variant, the artificial ligament 16 is directly attached to the means of adjustment 18.

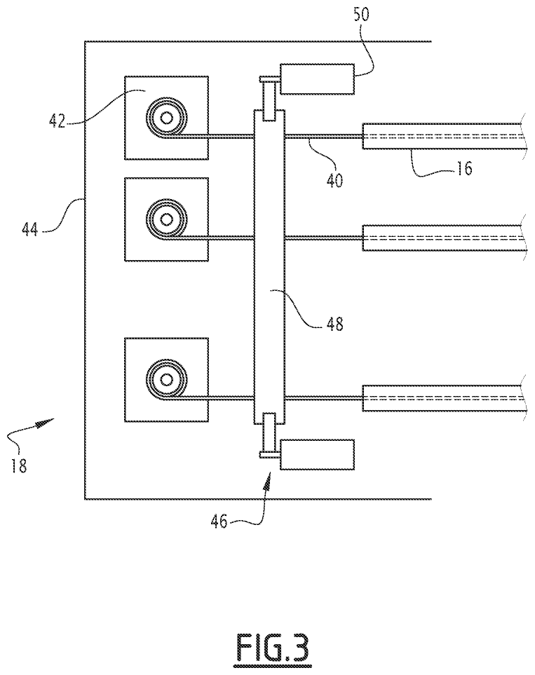

Thereby, as can be seen in FIG. 3, each dimensionally stable rope 40 is arranged between the means of adjustment 18 and the associated artificial ligament 16.

The simulator 10 further advantageously comprises fixed ligaments that are not adjustable in the sense that same are fixed between two anchoring points without the possibility of varying the length thereof. For example, the patellar ligament and the quadriceps tendon can be simulated in a non-modular way.

The means of adjustment 18 is configured to vary the length of each artificial ligament 16 between the two associated anchoring points 14, independently of the length of the other artificial ligaments 16. Thereby, the means of adjustment 18 is configured to vary the length of one of the artificial ligaments 16 between the two associated anchoring points 14 without varying the other lengths of the other artificial ligaments 16.

Advantageously, the means of adjustment 18 comprises at least two actuators 42. More particular, the means of adjustment 18 comprises an actuator 42 associated with each artificial ligament 16. Each actuator 42 is thereby connected, for simplicity, to a single artificial ligament 16, and is configured to vary the length of said artificial ligament 16.

Each actuator 42 is a motor, more particularly a stepper motor.

As a variant of the stepper motor attached to the artificial ligament 16 via the rope 40, the artificial ligament 16 is in the form of a spring with variable stiffness adjustable by an electromagnetic field. The actuator 42 is then configured to generate said electromagnetic field so as to adjust the stiffness of the artificial ligament 16, without modifying the length thereof.

The means of adjustment 18 is configured to receive, for each artificial ligament 16, an associated control signal. The means of adjustment 18 is then configured to automatically adjust the length or the stiffness of each artificial ligament 16 as a function of the associated control signal.

In other words, the means of adjustment 18 is configured to vary at least one biomechanical characteristic of each artificial ligament 16. The biomechanical characteristic is in particular the length of the artificial ligament 16 or the stiffness of the artificial ligament 16.

For example, the control signal is a position setpoint intended for the stepper motor. Thereby, by varying the step of the stepper motor, the fixed cord 40 winds to a variable extent around the axis of the stepper motor and thus varies the length of the associated artificial ligament 16, as can be seen in FIG. 3.

In a variant, the control signal is a stiffness setpoint intended for the magnetic field generator associated with the spring with variable stiffness. Thereby, by varying the magnetic field, the means of adjustment 18 thus varies the stiffness of the associated artificial ligament 16.

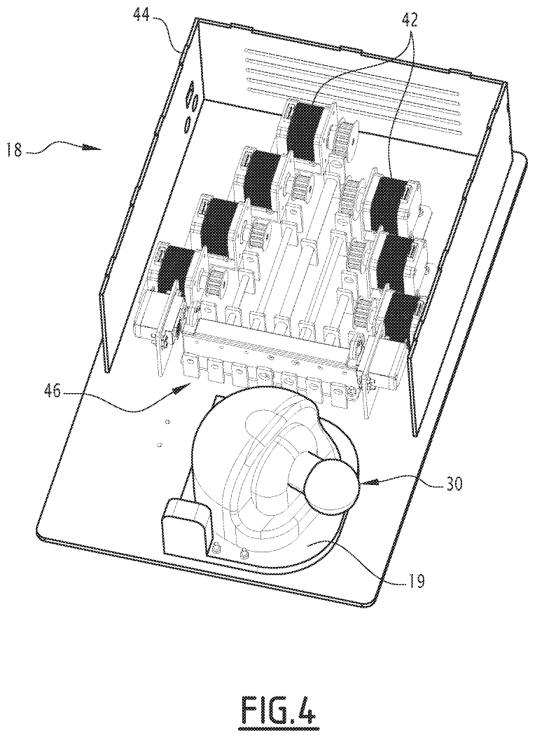

FIG. 4 shows seven stepper motors arranged in a box 44 the upper wall of which is not shown. The artificial ligaments 16 and the fixed ropes 40 are not shown either herein said figure.

The means of adjustment 18 further comprises a locking system 46 configured to hold the length of each artificial ligament 16 fixed between the two associated anchoring points 14.

The locking system 46 serves to save energy by preventing the actuator 42 from having to hold the different artificial ligaments 16 in the desired position.

More particularly, as can be seen in FIGS. 3 and 4, the locking system 46 comprises a jaw 48 that can be actuated by at least one motorized device 50, herein two motorized devices 50 as can be seen in FIG. 3. Each motorized device 50 in particular is a servomotor.

The jaw 48 is apt to be actuated between an open configuration wherein the artificial ligaments 16 are apt to slide freely in the jaw 48 and a closed configuration wherein the artificial ligaments 16 are held in a fixed position in the jaw 48.

The jaw 48 in particular is composed of two parts, each provided with holes letting through the artificial ligaments 16. One or a plurality of springs are arranged between the two parts. The servomotor comprises an oval end piece apt to press on the top piece so as to align the holes of the two pieces, thereby allowing the artificial ligaments 16 to slide. When the servomotor releases the pressure exerted on the top part, the holes lose the alignment thereof and the artificial ligaments 16 passing through are blocked.

The means of adjustment 18 and the locking system 46 are apt to be controlled by the control system 22.

The control system 22 is configured to receive an instruction from a user of the simulator 10 and to send a control signal for each artificial ligament 16 to the means of adjustment 18.

The control system 22 comprises, e.g., one microcontroller per actuator 42.

The control system 22 is connected to the database 24.

The database 24 includes data relating to at least two knee states. Each knee state is characterized by a predefined length for each artificial ligament 26 between the two anchoring points 14. Each knee state is e.g. a healthy condition, a partial rupture of the anterior cruciate ligament, a total rupture of the anterior cruciate ligament, a lesion of the posterolateral corner point, etc.

More particularly the knee state is characterized for each artificial ligament 16 by a length between the anchoring points 14 serving to model, if appropriate, a ligament lesion.

A ligament lesion is characterized by a grade. Grade 0 corresponds to a normal ligament without injury. The length of the artificial ligament 16 between the two anchoring points 14 is thus the nominal length. Grade 1 corresponds to a sprain, with pain and localized joint tenderness but without laxity. The associated length is thus also equal to the nominal length, there is no change in length compared to grade 0. Grade 1 can be associated with an audible signal emitted when simulator 10 is manipulated. Grade 2 corresponds to a partial or complete tear of the ligament with joint laxity. Grade 2 is also associated with localized pain and tenderness. Grade 2 is associated with an elongation of the length of the artificial ligament 16 between the two anchoring points 14, advantageously between 5 mm and 10 mm with respect to the nominal length. Finally, grade 3 corresponds to a complete tear of the ligament, with significant laxity and instability. Grade 3 is associated with an elongation of the length of the artificial ligament 16 between the two anchoring points 14, advantageously greater than 10 mm with respect to the nominal length. An audible signal can also be emitted when simulator 10 is manipulated for grades 2 and 3.

Thereby e.g. when the knee state is a total rupture of the anterior cruciate ligament, the artificial ligament 16 modeling the anterior cruciate ligament is associated with grade 3 and the associated length is thus increased by more than 10 mm. all the other artificial ligaments 16 being adjusted to the nominal length thereof.

The human-machine interface 20 is configured to acquire, from a user of the simulator 10. an instruction associated with one of the knee states.

The human-machine interface 20 is e.g. a touch screen. The touch screen is suitable for displaying different buttons corresponding to the different knee states available. When the user clicks on a button, the instruction associated with the selected knee state is sent to the control system 22. From the database 24, the control system 22 sends to the means of adjustment 18, a control signal for each artificial ligament 16 corresponding to the selected knee state.

The locking system 46 changes from the closed configuration holding the artificial ligaments 16 in position, to the open configuration wherein the artificial ligaments 16 are apt to slide freely in the jaw 48. The means of adjustment 18 then modifies the length of each artificial ligament 16 between the two anchoring points 14 according to the associated control signal received, one after the other. The locking system 46 then returns to the closed configuration in order to hold the artificial ligaments 16 in position.

It is thereby easy for the user to switch from one knee state to another and in particular to easily alternate between a healthy knee and a pathological knee in order to make a comparison possible, which is impossible in particular with a conventional simulator adjustable by hand.

In a variant, the human-machine interface 20 is software implemented on a computer or further a microphone.

Advantageously, at least one accelerometer 26 is attached to one of the artificial bones 12. Advantageously, an accelerometer 26 is attached to each artificial bone 12. Each accelerometer 26 is configured to measure the acceleration of the associated bone over time and is thus used to determine the movements performed by the user on the simulator 10.

The simulator 10 comprises a memory configured to store the acceleration measurements made by each accelerometer 26 over time. It is thereby possible, during a diagnosis performed by a student, e.g. to record the movements and tests performed by the student on the simulator, such as an anterior drawer test for diagnosing a rupture of the anterior cruciate ligament. Thereby, following the diagnosis made by the student, it is possible to provide a report that can possibly determine which tests have not been done, or not correctly, by the student and may possibly lead to a misdiagnosis.

Advantageously, the simulator 10 further comprises an envelope, not shown in the figures. The envelope simulates a skin of the patient and serves to surround the artificial bones 12 and to give a more realistic appearance to the simulator 10. For example, the envelope is made of a plastic material that is easily deformable.

The envelope defines an internal volume wherein the artificial bones are arranged. A foam fills the internal volume. The foam is chosen so as to make a knee flexion of about 120° possible.

Advantageously, at least one artificial meniscus is arranged between two artificial bones 12. For example, an artificial lateral meniscus and an artificial medial meniscus, produced from a copolymer. are anchored to the tibial surface.

Also advantageously, at least one artificial muscle is attached to two artificial bones 12. For example, a quadriceps is attached via the artificial tendon of the quadriceps to the artificial patella 36 and to the fixed point 19. More particularly, the quadriceps tendon is attached to the upper pole of the artificial patella and the patellar ligament is attached to the lower pole of the patella and joins the artificial tibia on the tibial tuberosity.

The simulator 10 simulates a patient's right knee or left knee by adapting the attachments of the artificial ligaments 16 to the bones.

Advantageously, two simulators 10 are arranged side by side, including a simulator 10 of a right knee and a simulator of a left knee. For example, one of the two simulators 10 is in a healthy state and the other simulator 10 is in an affected state. The user can then easily compare the two knees.

It thereby can be understood that the ligament knee simulator 10 according to the invention indeed serves for a precise, easy and rapid adjustment in order to simulate different multi-ligament pathologies of the knee.

The invention thus leads to a better assimilation of knowledge during medical studies and to a reduction of risks for the patient. The simulator serves for the learning of the clinical examination in physiological and pathological situations, as well as for the repetition of diagnosis maneuvers and for the evaluation of the knowledge each student has.

In addition, simulation serves to inform students about rare diagnoses that are often ignored in the real world. Moreover, the performance of an efficient clinical examination guides the prescription of additional examinations and reduces the number of unnecessary, invasive or costly examinations for the patient.

1. A ligament joint simulator comprising:
at least two artificial bones;
for each artificial bone, at least one anchoring point on the artificial bone;
at least one artificial ligament, the or each artificial ligament linking two anchoring points of a different artificial bone; and
an adjuster linked to the artificial ligaments, the adjuster configured to vary at least one biomechanical characteristic of each artificial ligament between the two associated anchoring points independently of the other artificial ligaments;
wherein the adjuster is configured to receive, for each artificial ligament, an associated control signal; and
the adjuster is configured to automatically adjust the length of each artificial ligament based on the associated control signal.

2. The simulator according to claim 1, wherein the ligament simulator is a ligament knee simulator, at least two artificial bones each being selected from the group consisting of: an artificial femur, an artificial tibia, an artificial patella, and an artificial fibula.

3. The simulator according to claim 1, wherein at least two artificial ligaments have a different cross-section surface area.

4. The simulator according to claim 1, wherein each artificial ligament is composed of a material chosen from the group consisting of:
polypropylene;
polyamide;
elastomer material; and
silicone.

5. The simulator according to claim 1, wherein each artificial ligament consists of a spring with variable stiffness arranged between the two associated anchoring points.

6. The simulator according to claim 1, wherein the adjuster comprises at least two actuators, each actuator being linked to a single artificial ligament and configured to vary the length of the ligament according to the associated control signal.

7. The simulator according to claim 1, wherein the adjuster further comprises a locking system configured to hold the length of each artificial ligament fixed between the two associated anchoring points.

8. The simulator according to claim 7, wherein the locking system comprises a jaw which can be actuated by at least one motorized device, the jaw being apt to be actuated between an open configuration wherein the artificial ligaments are apt to slide freely in the jaw and a closed configuration wherein the artificial ligaments are held in a fixed position in the jaw.

9. The simulator according to claim 1, further comprising a fixed support, at least one artificial bone being connected to the fixed support by a ball joint.

10. The simulator according to claim 1, further comprising a human-machine interface, a control system and a database,
the database including data relating to at least one knee state, the or each knee state being characterized by a predefined length for each artificial ligament between the two associated anchoring points;
the human-machine interface being configured to acquire, from a user of the simulator, an instruction associated with one of the knee states,
the control system being configured to receive said instruction and to send to the adjuster a control signal for each artificial ligament corresponding to the predefined length associated with said knee state in the database.

11. The simulator according to claim 1, further comprising at least one accelerometer attached to one of the artificial bones and a memory configured to store acceleration measurements made by each accelerometer over time.

12. The simulator according to claim 1, further comprising an envelope defining an internal volume wherein the artificial bones are arranged, a foam filling the internal volume.

13. The simulator according to claim 4, wherein each artificial ligament is composed of nylon.

14. The simulator according to claim 6, wherein the two actuators are two stepper motors.

15. The simulator according to claim 8, wherein the motorized device is a servomotor.
